(19) United States
(12) Patent Application Publication
(10) Pub. No.: US 2026/0093533 A1
(43) Pub. Date: Apr. 2, 2026

(54) PORT RESOURCE MANAGEMENT WITHIN A MULTI-PORT MEMORY SYSTEM

(71) Applicant: Micron Technology, Inc., Boise, ID (US)

(72) Inventors: John E. Maroney, Irvine, CA (US); Pedro Cordon, Irvine, CA (US); Henry H. Torabi, Irvine, CA (US); Robert W. Strong, El Dorado Hills, CA (US)

(21) Appl. No.: 19/338,707

(22) Filed: Sep. 24, 2025

Related U.S. Application Data
(60) Provisional application No. 63/701,276, filed on Sep. 30, 2024.

(51) Int. Cl. G06F 9/50; G06F 13/16; G06F 21/44

(52) U.S. Cl. CPC G06F 9/5016; G06F 13/1668; G06F 21/44

(57) ABSTRACT

Methods, systems, and devices for port resource management within a multi-port memory system are described. A memory system may include multiple ports each coupled with one or more host systems. The memory system may receive a command defining a secure management port via an interface with a management controller or via another port. In some cases, the defined management port may be a dedicated port, or may be selected during one or more power-on procedures. The command may also indicate a quantity of ports to be activated, and may be based on an attestation of one or more host systems. In some examples, the memory system may use the management port to receive additional communications and commands. For example, the management port may receive and execute commands for resource allocation, additional configurations, sub-system operations including power management and reset, or for diagnostic functions, among other operations.

### CROSS REFERENCE

The present Application for Patent claims priority to U.S. patent application No. 63/701,276 by Maroney et al., entitled “PORT RESOURCE MANAGEMENT WITHIN A MULTI-PORT MEMORY SYSTEM,” filed Sep. 30, 2024, which is assigned to the assignee hereof, and which is expressly incorporated by reference in its entirety herein.

### TECHNICAL FIELD

The following relates to one or more systems for memory, including port resource management within a multi-port memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports port resource management within a multi-port memory system in accordance with examples as disclosed herein.

FIG. 2 shows an example of an architecture that supports port resource management within a multi-port memory system in accordance with examples as disclosed herein.

FIG. 3 shows an example of a system that supports port resource management within a multi-port memory system in accordance with examples as disclosed herein.

FIG. 4 shows a block diagram of a memory system that supports port resource management within a multi-port memory system in accordance with examples as disclosed herein.

FIGS. 5 and 6 show flowcharts illustrating a method or methods that support port resource management within a multi-port memory system in accordance with examples as disclosed herein.

### DETAILED DESCRIPTION

Some memory systems may include multiple ports (e.g., functions). Each port may include or otherwise be associated with or more resources or hardware components within the memory system (e.g., on a solid state device (SSD)). Some systems (e.g., automotive systems) may include a single memory system associated with (e.g., coupled with, in communication with) multiple host systems. For example, multiple host systems in a system may access a single multi-ported memory system (e.g., multi-ported SSD). In such an example, each port of the memory system may correspond to a respective physical connection with one or more external host systems. The host systems may communicate with the memory system via the one or more ports and corresponding interfaces to access data stored within the memory system. Definitions and procedures for securing input/output (I/O) communication via different ports in a multi-port memory system, as well as security measures for sub-system resource management and other sub-system operations and communications may be beneficial to improve security for multi-port memory systems.

Techniques described herein may support port resource management by a trusted port within a multi-port memory system. A memory system including multiple ports may receive, via an interface with a management controller or via another port, a command defining a secure management port (e.g., resource management port). In some cases, the management port may be a dedicated port (e.g., configured during manufacture), or may be selected during one or more power-on procedures (e.g., selected by a user or other administrator of the system). The command may also indicate a quantity of ports to be used by (e.g., activated within) the memory system. For example, some quantity of available ports that may be coupled with one or more host systems. The quantity of ports may be based on an attestation of one or more host systems, including a trusted host system coupled with the management port, in some examples. The memory system may use the defined management port to receive and execute one or more additional commands for resource allocation, one or more additional configurations, one or more sub-system operations including power management and reset, one or more diagnostic functions, other operations associated with privileged commands, or any combination thereof. The resources may include, for example, command slots for buffering or queuing commands received via each of the one or more ports, storage capacity (e.g., namespaces within memory devices) for storing data or metadata (e.g., firmware, attestation information, or the like) associated with each port, or the like.

By using a single trusted port for resource management as well as for communication of other configuration or operation commands, a multi-ported system may have increased security and be less vulnerable to attacks than systems in which multiple ports are able to manage resource allocation. Additionally, such commands may allow a management port to be flexibly configured, allowing changing of a management port based on one or more factors (e.g., based on a module upgrade to a more secure host). In some examples, the memory system may represent an example of or otherwise be included within an automotive system (e.g., an automotive SSD) or another type of system associated with relatively high reliability and security requirements, and the techniques described herein for port resource management within a multi-port memory system may improve security and data integrity within the automotive system, thereby increasing user experience and mitigating risks from security attacks, among other examples. For example, one or more host systems (e.g., functions, applications) within an automotive system may be less susceptible to attack or hacks than other host systems, and such host systems may be designated as the management host systems to be coupled with the management port(s), which may improve security and reliability of the resource management and allocation functions within the automotive system.

In addition to applicability in memory systems described herein, techniques for port resource management within a multi-port memory system may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by allowing a multi-ported memory storage device (e.g., a multi-ported SSD device) to use a single trusted port for resource allocation and other command communication and execution to prevent attacks from other ports, improving security be comparable to that of, if not more secure than, a single ported device, among other benefits. Additionally, the memory system may be implemented within an automotive system (e.g., an automotive SSD), and may thereby support relatively increased security for the automotive system using the resource management techniques described herein.

Features of the disclosure are illustrated and described in the context of systems, devices, and circuits. Features of the disclosure are further illustrated and described in the context of architectures, systems, block diagrams, and flowcharts.

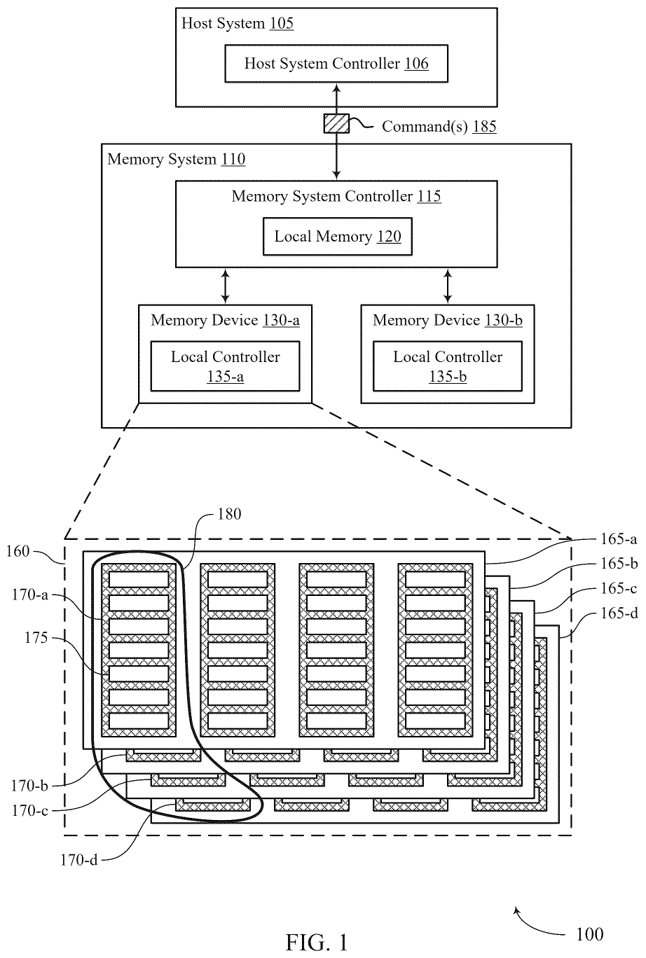

FIG. 1 shows an example of a system 100 that supports port resource management within a multi-port memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the system 100 may support port resource management within a multi-port memory system as described herein. For example, the memory system 110 may be a multi-port memory system coupled with multiple host systems, where each port may be coupled with one or more of the host systems, including the host system 105. In some cases, the memory system 110 may be coupled with the host system 105 via a trusted port or interface, via which the memory system 110 may receive one or more commands 185. In some cases, the command 185 may define a secure management port, which may be a dedicated port, or may be selected during one or more power-on procedures of the memory system 110. The command 185 may also indicate a quantity of ports to be activated, and may be based on an attestation of one or more host systems. After receiving the command 185, the memory system 110 may use the defined management port to receive and execute additional communications and commands, including commands for resource allocation (e.g., for managing resources), additional configurations, sub-system operations, or diagnostic functions, among other operations.

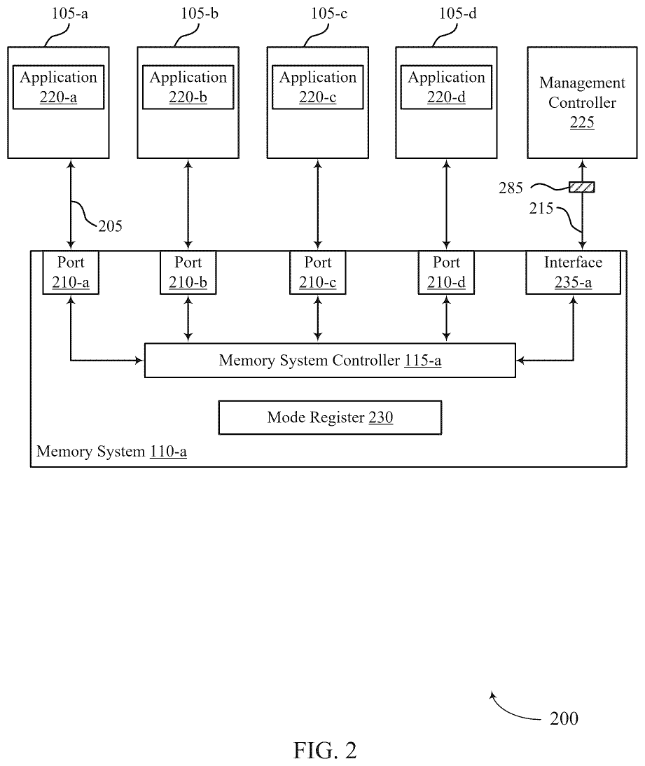

FIG. 2 shows an example of an architecture 200 that supports port resource management within a multi-port memory system in accordance with examples as disclosed herein. One or more aspects of the architecture 200 may implement or may be implemented by one or more aspects of the system 100. For example, the architecture 200 may include a host system 105-a, a host system 105-b, a host system 105-c, a host system 105-d, and a memory system 110-a with a memory system controller 115-a and a mode register 230, which may be examples of corresponding devices or systems described herein. In some cases, the architecture 200 may be implemented in or as part of an automotive system, and architecture 200 may support increased security by selecting a trusted management port.

For example, memory system 110-a may be a multi-ported memory system and may include a port 210-a, a port 210-b, a port 210-c, and a port 210-d. The ports 210 may allow for multiple host systems 105 to establish connections with the memory system 110-a and to execute commands using the memory system 110-a for executing applications 220 (e.g., or functions). For example, a host system 105-a may be coupled with the memory system 110-a via the port 210-a and may host (e.g., and may execute commands for) an application 220-a. A host system 105-b may be coupled with the memory system 110-a via the port 210-b and may host an application 220-b, a host system 105-c may be coupled with the memory system via the memory system 110-a via the port 210-c and may host an application 220-c, and a host system 105-d may be coupled with the memory system 110-a via the port 210-d and may host an application 220-d. In some examples, each port 210 may operate independently. For example, each port 210 may involve different link speeds (e.g., PCIe link speeds) or may be reset independently. Further, the ports 210 may operate simultaneously or concurrently, or at different times. In some cases, boot partitions, replay protected memory blocks (RPMBs), virtualization (e.g., single root I/O virtualization (SRIOV)), and resource allocation may also be per port.

Although the architecture 200 illustrates four host systems 105 and four ports 210, it is to be understood that a memory system may include any quantity and combination of ports and host systems, including four of each, or any other quantities. The memory system 110-a may include one or more memory arrays across one or more memory devices that store data for the execution of the various applications. The ports may provide an interface for communicating commands and data with the host systems 105, but the actual data for each host system 105 may be stored in various locations within the memory system 110-a.

In some examples, the host systems 105 may transmit commands (e.g., in-band commands) that are associated with execution of an application 220. The host systems 105 may be controlled by or may include one or more components or systems of an automotive platform, and applications 220 may support one or more functions of the automotive platform or some other type of platform. Such commands may be communicated to the memory system 110-a via a peripheral component interconnect (PCI) interface 205 between a host system 105 and a port 210 of the memory system 110-a, which may be referred to as an in-band channel. The host systems 105 may communicate with the memory system 110-a using the ports 210 via in-band signaling (e.g., via a PCIe bus) which may differ from out-of-band (OOB) signaling, as the PCI interface 205 may support transfer of data and commands, while one or more OOB channels may not be used for data transfer, but may instead be used for transfer of metadata and other management commands. Commands sent by a host system 105 may cause or instruct the memory system controller 115-a to execute operations and/or access memory (e.g., at one or more memory devices 130 of the memory system 110-a). The commands may be non-volatile memory express (NVMe) commands, or some other type of command.

In some examples, the memory system 110-a may include an interface 235-a (e.g., a management port) which may be used for managing one or more aspects of the memory system 110-a. In some examples, the memory system 110-a may use the interface 235-a for authentication of the host systems 105 prior to the memory system 110-a granting the host systems 105 access to the ports 210. For example, the memory system 110-a may grant a management controller 225 access to the interface 235-a based on an attestation process between the memory system 110-a and the authentication management controller 225. The authentication management controller 225 and the memory system 110-a may perform the attestation process by transmitting OOB signaling 215 via a system channel bus (e.g., an inter-integrated circuit (I2C) bus, a system management bus (SMBus)). Additionally, or alternatively, the OOB signaling 215 may be one or more vendor defined messages that are transmitted via an NVMe management interface (NVMe-MI), or some other interface. In some examples, the management controller 225 may be an example of a separate management controller with a separate management operating system, or may be an example of a combined host processor and management controller. If the management controller 225 is within a host system 105, the management controller 225 may communicate with the interface 235-a (e.g., a port) via an in-band interface, in some examples.

Once authenticated with the memory system 110-a, the management controller 225 may (e.g., via the OOB signaling 215) request that any one or more host systems 105 gain access (e.g., privileged access) to a respective port 210 of the memory system 110-a (or such ports may request to be a trusted port). For example, the authentication management controller 225 may transmit one or more commands that request that the host system 105-a gain privileged access to the port 210-a, that the host system 105-b gain privileged access to the port 210-b, and so on.

In accordance with examples described herein, the memory system 110-a may further increase security by selecting or determining a port (e.g., a central core or function) for requesting resource changes after attestation. For example, the memory system 110-a may select a trusted port, or function, on a decentralized hub for a security infrastructure that manages security of other ports 210 based on the attestation. In some examples, the memory system 110-a may be configured with a single trusted management port to prevent security breaches from other ports 210. For example, the memory system 110-a may receive a command 285 via a trusted interface or port (e.g., via the interface 235-a, via a trusted port 210) that may indicate the trusted management port. Additionally, or alternatively, the interface 235-a may be the default trusted management port based on the interface 235-a being coupled with the management controller 225 via an OOB connection, or some other port may be a default. In some examples, if the trusted management port is the interface 235-a, the management controller 225 may run a corresponding resource management application.

In some examples, the secure management port may accept commands that are otherwise restricted for other ports 210. For example, the management port (e.g., the interface 235-a, another port 210) may accept vendor defined commands, including commands associated with configuring resources. The management port may also accept commands for setting up virtualization management, namespace configurations, firmware download and commit, among other vendor specific commands associated with user data or firmware. Further, other subsystem operations, such and power management and resets, as well as diagnostic functions, may be accepted and executed by the trusted management port. Such additional operations may be referred to as privileged operations herein. That is, the trusted management port may execute one or more privileged commands.

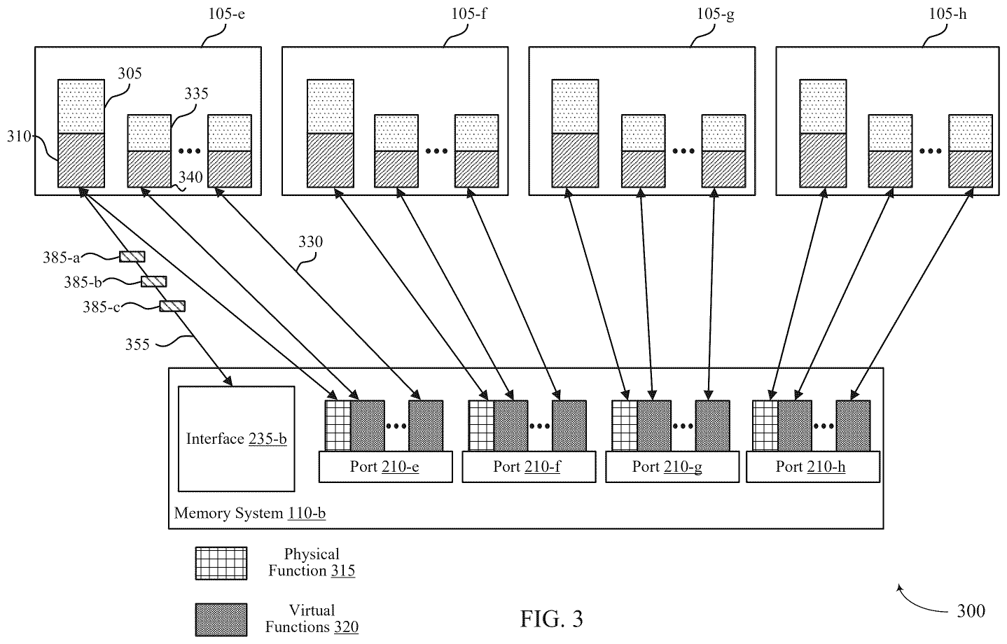

In some cases, by using a single trusted management port, a security of a multi-ported device (e.g., SSD device, an automotive system), such as the memory system 110-a, may be increased by restricting command access for other ports 210 in systems of automotive platforms or other environments. Further, a management port using secure NVMe-MI management may be more secure than some single-ported devices. Additionally, or alternatively, a resource management port may be flexibly configured to allow a user to change the management port for different operations (e.g., to change the port based on a module upgrade to a more secure host). In some examples, the memory system 110-a may store data for applications associated with relatively high reliability and security requirements, such as a vehicle or other automated system. In such cases, the designation of a trusted management port may reduce a likelihood of attacks or hacks to the system, as the trusted management port may be associated with a more secure connection than other ports and may thereby be less vulnerable to malicious actors, among other examples. Techniques for modifying resource allocations and other port configurations by the trusted management port are described in further detail elsewhere herein, including with reference to FIG. 3.

FIG. 3 shows an example of a system 300 that supports port resource management within a multi-port memory system in accordance with examples as disclosed herein. One or more aspects of the system 300 may implement or may be implemented by one or more aspects of the system 100 and the architecture 200. For example, the system 300 may include a memory system 110-b that may be coupled with one or more host systems 105 via one or more ports 210, including host systems 105-e, 105-f, 105-g, and 105-h (e.g., host systems on chips (SOCs)) and ports 210-e, 210-f, 210-g, and 210-h, which may represent examples of the memory systems 110 and 110-a, the host systems 105, and the ports 210. In some examples, the system 300 may support port resource management and other command execution using one or more trusted ports as described herein.

For example, each of the ports 210-e through 210-h may be coupled with a respective management operating system 305 and driver 310 (e.g., an NVMe+NVMe-MI driver) of a respective host system 105. Further, in some cases, the connections may be via a channel 330 of the port and a physical function 315 of the memory system 110-b (e.g., a same physical function shared across all ports), where each port may include one or more respective virtual functions 320. In some examples, each port may involve a different physical function with respective virtual functions 320. Further, each port 210 may include channels 330 that may couple virtual functions 320 with corresponding host operating systems 335 and drivers 340 of the host systems 105-e through 105-h (e.g., via a host interface in accordance with a communication protocol). The memory system 110-b may also include an interface 235-b (e.g., including a management endpoint) coupled with a driver 310 of a management operating system 305 of the host system 105-e (or of a separate management controller) via a channel 355 (e.g., a system management channel, an I2C bus or SMBus). In some examples, the host systems 105 may be controlled by or may include one or more components or systems of an automotive platform and may execute one or more automotive applications.

In some examples, after receiving one or more commands 385-a associated with an attestation of one or more host systems 105 as described herein, the memory system 110-b may receive a command 385-b (e.g., a command for setting ports, referred to as a set-all ports command). The command 385-b may indicate a port 210 as a trusted management port (e.g., resource management port) to support execution of additional commands. In some cases, the indicated port may be a dedicated management port (e.g., a single port trusted for management operations). For example, the command 385-b may indicate the interface 235-b, or may indicate one of the ports 210 as a dedicated management port. Additionally, or alternatively, the management port may be chosen on power up as any of one or more trusted ports 210. For example, if identified as a trusted port during attestation, any of the support ports 210-e through 210-h may be selected and indicated in the command 385-c, even if attestation is first performed using one or more commands 385-a via the interface 235 (e.g., via an SMBus). In some examples, such an indication may overwrite a previously stored trusted management port. In some cases, during attestation, a first port that is selected as trusted may be indicated, or such a selection may rotate among activated ports. Further, while illustrated as received via the interface 235-b, the command 385-b (and 385-a) may be received via any of the channels 330 of the ports 210-e through 210-h.

Additionally, or alternatively, the command 385-b may indicate one or more additional parameters or features, including resources. For example, the command 385-b may indicate a quantity of ports, of multiple ports of the memory system 110-b, to be activated. For example, the command 385-b may indicate a single port, two ports, three ports, up to a total of four ports to be activated (e.g., used by the memory system 110-b or otherwise coupled with external host systems), or any other quantity of ports. The command 385-b may further indicate a trusted computing group (TCG) port, which may be the same as or different from the resource management port, one or more quantities of lanes for each port 210, a density mode, port numbers associated with enabled or disabled virtualization (e.g., single root I/O virtualization (SRIOV) or non-SRIOV), a maximum quantity of virtual functions for each port, a maximum quantity of namespaces (e.g., logical block address (LBA) ranges), a cache type (e.g., whether dynamic cache or volatile write cache is enabled or disabled), among other parameters and values. In some cases, setting a quantity of ports may automatically divide queue resources (e.g., queue pairs, command slots) and interrupt resources evenly across the ports 210-e through 210-h, and may bifurcate PCIe lanes (e.g., corresponding to channels 330) across the activated ports 210. Further, receive and transmit pairs of PCIe with host operating systems 335, reset functions, and maximum virtual functions 320 per port may be configured, including the associations and connections illustrated in FIG. 3.

In some examples, the trusted management port may be used for executing additional commands. For example, the memory system 110-b may receive, at the trusted management port (e.g., via interface 235-b or an indicated port 210), one or more commands 385-c. In some cases, the one or more commands 385-c may be based on the attestation of one or more host systems 105, where at least one command may be to allocate resources of the memory system 110-b to the quantity of ports. For example, one or more commands 385-c may indicate resources, including command slots, queue resources and interrupt resources (e.g., admin related, fixed I/O related, flexible pools allocated via vendor defined command for physical function or virtual functions, etc.), function resources (e.g., virtual functions 320), cache resources, and namespaces, among other resources, for each of the ports 210-e through 210-h. Further, a maximum quantity of resources may be indicated for a function. Other resources or signals may be shared across ports 210 (e.g., CLKREQ across ports, SMBus and SMBus Alert, Power Loss Notification (PLN) and Power Loss Alert (PLA), among other examples). Using the indication of resources, the memory system 110-b may allocate, to each port 210, a respective set of resources. After allocating the resources, the memory system 110-b may receive and execute respective access commands for each active port 210.

The trusted management port may further be used to execute additional commands that may otherwise be restricted at other ports (e.g., may be dedicatedly performed at the trusted port). For example, the management port may support execution of commands 385-c (e.g., via a corresponding physical function 315) associated with accessing user data or firmware of the memory system 110-b. Such commands may be, for example, associated with setting one or more values for or performing one or more data or firmware operations, among other operations involving the memory system 110-b or other components of the system 300 (e.g., setting power management, temperature threshold, error recovery, volatile write cache, autonomous power state transition, host controlled thermal management, non-operational power state configuration, host behavior support, namespace management, firmware commit or image download, device self-test, namespace attachment, virtualization management, clock management, NVMe-MI send or receive, capacity management or managing endurance groups, sanitize, among other commands).

Additionally, or alternatively, the management port may support execution of commands 385-c that may be sub-system operation commands 385-c, including power management commands and reset commands (e.g., resets for NVM subsystems, functions, PCIe and PCIe link, and controllers, among other systems), among other privileged commands. In some examples, reset commands may be per physical function 315, per virtual function 320, or for both, and may involve disable or reset of one or more virtual functions.

The first port may also support execution of diagnostic commands, where at least a command 385-c may be a diagnostic command (e.g., self-test, safety mechanism check, error injection, loopback test, authentication, among other diagnostic commands). In some examples, other non-selected ports 210 may not be trusted, and may restrict execution of commands 385-c in accordance with one or more communication protocols (e.g., may respond with a path related status or controller path error).

In some examples, utilizing the commands 385-a, 385-b, and 385-c may thus support configuration of and use of a single management port for resource management and for communication of additional commands. By using a single management port (e.g., the interface 235-b or one of the ports 210-e through 210-f) for resource management or communication of other commands involving user data, firmware, or diagnostics (e.g., the one or more commands 385-c), the memory system 110-b may have increased security and be less vulnerable to attacks than systems in which multiple ports are able to manage resource allocation. Additionally, utilizing a command indicating a trusted port (e.g., the command 385-b), among other commands, may support changing of a management port based on one or more factors (e.g., based on a module upgrade to a more secure host), increasing flexibility of system configurations. The memory system 110-b may, in some cases, represent an example of or otherwise be included within an automotive system (e.g., an automotive SSD) or another type of system associated with relatively high reliability and security requirements. The techniques described herein for port resource management within the multi-port memory system 110-b may improve security and data integrity within the automotive system, thereby increasing user experience and mitigating risks from security attacks, among other examples. For example, one or more of the host systems 105-e through 105-h (e.g., functions, applications) may be less susceptible to attack or hacks than other host systems 105, and may be designated as management host system(s) to be coupled with management port(s), improving security and reliability of the resource management and allocation functions within the automotive system.

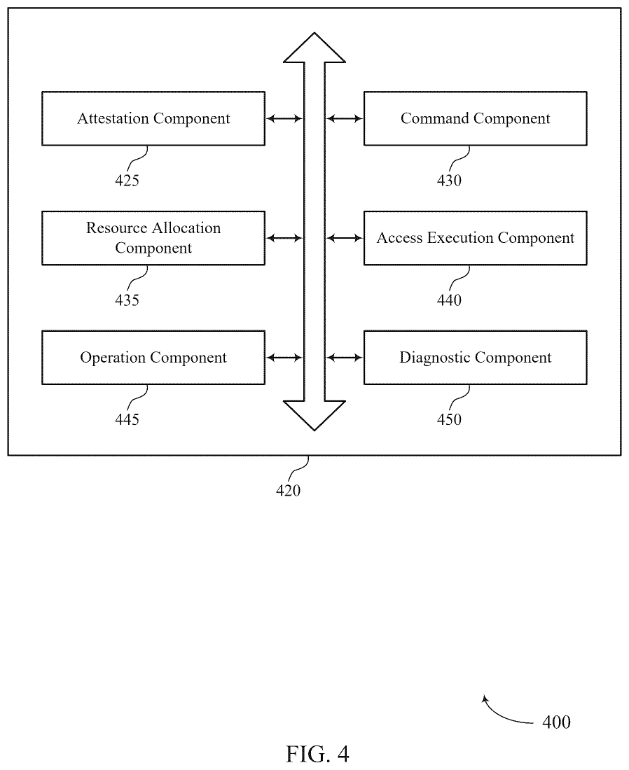

FIG. 4 shows a block diagram 400 of a memory system 420 that supports port resource management within a multi-port memory system in accordance with examples as disclosed herein. The memory system 420 may be an example of aspects of a memory system as described with reference to FIGS. 1 through 3. The memory system 420, or various components thereof, may be an example of means for performing various aspects of port resource management within a multi-port memory system as described herein. For example, the memory system 420 may include an attestation component 425, a command component 430, a resource allocation component 435, an access execution component 440, an operation component 445, a diagnostic component 450, or any combination thereof. Each of these components, or components of subcomponents thereof (e.g., one or more processors, one or more memories), may communicate, directly or indirectly, with one another (e.g., via one or more buses).

The attestation component 425 may be configured as or otherwise support a means for receiving, at a first port of a plurality of ports of a memory system and from a first host system of a plurality of host systems, one or more commands associated with an attestation of the first host system. The command component 430 may be configured as or otherwise support a means for receiving, at the first port from the first host system based at least in part on the attestation of the first host system, a first command that indicates a quantity of ports, of the plurality of ports of the memory system, to be activated. In some examples, the command component 430 may be configured as or otherwise support a means for receiving, at the first port from the first host system based at least in part on the attestation of the first host system, at least one second command, of one or more second commands, to allocate a plurality of resources of the memory system to the quantity of ports, where each port of the quantity of ports is coupled with one or more respective host systems of the plurality of host systems. The resource allocation component 435 may be configured as or otherwise support a means for allocating, to each port of the quantity of ports based at least in part on the one or more second commands, a respective set of resources of the plurality of resources.

In some examples, the command component 430 may be configured as or otherwise support a means for receiving, via the first command, an indication that the first port is a trusted resource management port, where the first port supports execution of the one or more second commands based at least in part on the indication.

In some examples, the command component 430 may be configured as or otherwise support a means for receiving, via a system management channel coupled with the memory system, a second command indicating that the first port is a trusted resource management port, where the first port supports execution of the one or more second commands based at least in part on the second command.

In some examples, the command component 430 may be configured as or otherwise support a means for receiving, at one or more second ports of the quantity of ports, one or more access commands. In some examples, the access execution component 440 may be configured as or otherwise support a means for executing, at the one or more second ports, respective access commands of the one or more access commands based at least in part on the respective set of resources allocated to the one or more second ports.

In some examples, the at least one second command, a subsequent second command of the one or more second commands, or both, is associated with allocating access to user data, firmware, or both of the memory system to the quantity of ports.

In some examples, the command component 430 may be configured as or otherwise support a means for receiving, at the first port, a subsequent second command of the one or more second commands that includes a power management command, a reset command, one or more other privileged commands, or any combination thereof. In some examples, the operation component 445 may be configured as or otherwise support a means for executing a power management operation, a reset operation, or both based at least in part on the subsequent second command.

In some examples, the command component 430 may be configured as or otherwise support a means for receiving, at the first port, a subsequent second command of the one or more second commands that includes a diagnostic command. In some examples, the diagnostic component 450 may be configured as or otherwise support a means for executing a diagnostic function based at least in part on the diagnostic command.

In some examples, to support allocating the respective set of resources to each port of the quantity of ports, the resource allocation component 435 may be configured as or otherwise support a means for allocating, to each port of the quantity of ports, a same quantity of one or more resources based at least in part on the first command that indicates the quantity of ports.

In some examples, the plurality of resources includes command slots, namespace configurations, function resources, cache resources, interrupt resources, or any combination thereof.

In some examples, the first port includes a system management interface coupled with a system management controller.

In some examples, the command component 430 may be configured as or otherwise support a means for receiving, at a memory system and via a system management channel coupled with the memory system, a first command that indicates a first port of a plurality of ports of the memory system is a trusted resource management port, where the trusted resource management port supports execution of one or more second commands, and where one or more second ports of the plurality of ports of the memory system restrict execution of the one or more second commands based at least in part on the first command.

In some examples, the command component 430 may be configured as or otherwise support a means for receiving, at the trusted resource management port of the memory system, at least one second command, of the one or more second commands, that indicates an allocation configuration for allocating a plurality of resources of the memory system across the plurality of ports within the memory system. In some examples, the resource allocation component 435 may be configured as or otherwise support a means for allocating, to each port of the plurality of ports based at least in part on the at least one second command of the one or more second commands, a respective set of resources, of the plurality of resources, for execution of one or more subsequent second commands, of the one or more second commands, that are received at the plurality of ports.

In some examples, the at least one second command, at least one of the one or more subsequent second commands received at the first port, or both, is associated with accessing user data or firmware of the memory system, and the first port supports execution of commands associated with accessing the user data or the firmware of the memory system.

In some examples, at least one of the one or more subsequent second commands received at the first port includes a power management command or a reset command, and the first port supports execution of sub-system operation commands.

In some examples, at least one of the one or more subsequent second commands received at the first port includes a diagnostic command, and the first port supports execution of diagnostic commands.

In some examples, a same quantity of one or more respective resources is allocated to each port based at least in part on a quantity of ports, of the plurality of ports of the memory system; and the first command indicates the quantity of ports.

In some examples, the plurality of resources includes command slots, namespace configurations, function resources, cache resources, interrupt resources, or any combination thereof.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

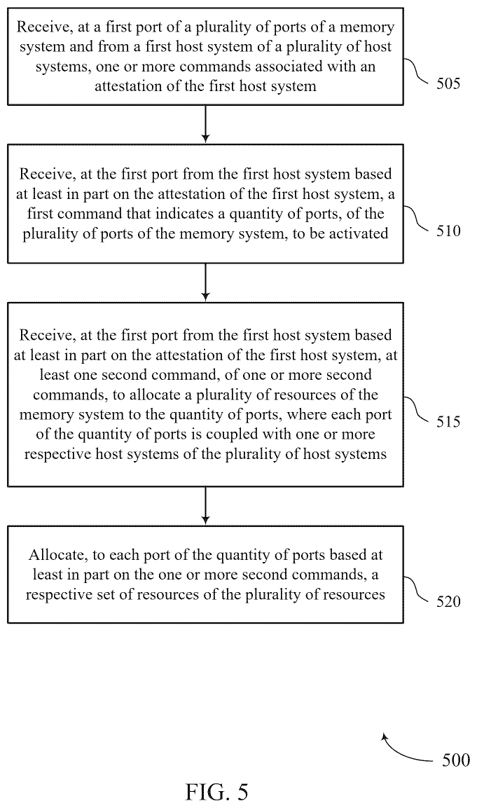

FIG. 5 shows a flowchart illustrating a method 500 that supports port resource management within a multi-port memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, at a first port of a plurality of ports of a memory system and from a first host system of a plurality of host systems, one or more commands associated with an attestation of the first host system. In some examples, aspects of the operations of 505 may be performed by an attestation component 425 as described with reference to FIG. 4.

At 510, the method may include receiving, at the first port from the first host system based at least in part on the attestation of the first host system, a first command that indicates a quantity of ports, of the plurality of ports of the memory system, to be activated. In some examples, aspects of the operations of 510 may be performed by a command component 430 as described with reference to FIG. 4.

At 515, the method may include receiving, at the first port from the first host system based at least in part on the attestation of the first host system, at least one second command, of one or more second commands, to allocate a plurality of resources of the memory system to the quantity of ports, where each port of the quantity of ports is coupled with one or more respective host systems of the plurality of host systems. In some examples, aspects of the operations of 515 may be performed by a command component 430 as described with reference to FIG. 4.

At 520, the method may include allocating, to each port of the quantity of ports based at least in part on the one or more second commands, a respective set of resources of the plurality of resources. In some examples, aspects of the operations of 520 may be performed by a resource allocation component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a first port (e.g., interface 235, dedicated or chosen port 210) of a plurality of ports of a memory system and from a first host system of a plurality of host systems, one or more commands (e.g., one or more commands 385-a) associated with an attestation of the first host system; receiving, at the first port from the first host system based at least in part on the attestation of the first host system, a first command (e.g., command 385-b) that indicates a quantity of ports, of the plurality of ports of the memory system, to be activated; receiving, at the first port from the first host system based at least in part on the attestation of the first host system, at least one second command, of one or more second commands (e.g., command(s) 385-c), to allocate a plurality of resources of the memory system to the quantity of ports, where each port of the quantity of ports is coupled with one or more respective host systems of the plurality of host systems; and allocating, to each port of the quantity of ports based at least in part on the one or more second commands, a respective set of resources of the plurality of resources.

Aspect 2: The method, apparatus, or non-transitory computer-readable medium of aspect 1, further including operations, features, circuitry, logic, means, or instructions, or any combination thereof for receiving, via the first command, an indication that the first port is a trusted resource management port, where the first port supports execution of the one or more second commands based at least in part on the indication.

Aspect 3: The method, apparatus, or non-transitory computer-readable medium of any of aspects 1 through 2, further including operations, features, circuitry, logic, means, or instructions, or any combination thereof for receiving, via a system management channel (e.g., channel 355, IC2 bus, SMBus) coupled with the memory system, a second command indicating that the first port is a trusted resource management port, where the first port supports execution of the one or more second commands based at least in part on the second command.

Aspect 4: The method, apparatus, or non-transitory computer-readable medium of any of aspects 1 through 3, further including operations, features, circuitry, logic, means, or instructions, or any combination thereof for receiving, at the quantity of ports including the first port and one or more second ports, one or more access commands and executing, at the quantity of ports, respective access commands of the one or more access commands based at least in part on the respective set of resources allocated to the quantity of ports.

Aspect 5: The method, apparatus, or non-transitory computer-readable medium of any of aspects 1 through 4, where the at least one second command, a subsequent second command of the one or more second commands, or both, is associated with allocating access to user data, firmware, or both of the memory system to the quantity of ports.

Aspect 6: The method, apparatus, or non-transitory computer-readable medium of any of aspects 1 through 5, further including operations, features, circuitry, logic, means, or instructions, or any combination thereof for receiving, at the first port, a subsequent second command of the one or more second commands that includes a power management command, a reset command, or both and executing a power management operation, a reset operation, one or more other privileged commands, or any combination thereof based at least in part on the subsequent second command.

Aspect 7: The method, apparatus, or non-transitory computer-readable medium of any of aspects 1 through 6, further including operations, features, circuitry, logic, means, or instructions, or any combination thereof for receiving, at the first port, a subsequent second command of the one or more second commands that includes a diagnostic command and executing a diagnostic function based at least in part on the diagnostic command.

Aspect 8: The method, apparatus, or non-transitory computer-readable medium of any of aspects 1 through 7, where allocating the respective set of resources to each port of the quantity of ports includes operations, features, circuitry, logic, means, or instructions, or any combination thereof for allocating, to each port of the quantity of ports, a same quantity of one or more resources based at least in part on the first command that indicates the quantity of ports.

Aspect 9: The method, apparatus, or non-transitory computer-readable medium of any of aspects 1 through 8, where the plurality of resources includes command slots, namespace configurations, function resources, cache resources, interrupt resources, or any combination thereof.

Aspect 10: The method, apparatus, or non-transitory computer-readable medium of any of aspects 1 through 9, where the first port includes a system management interface (e.g., interface 235) coupled with a system management controller.

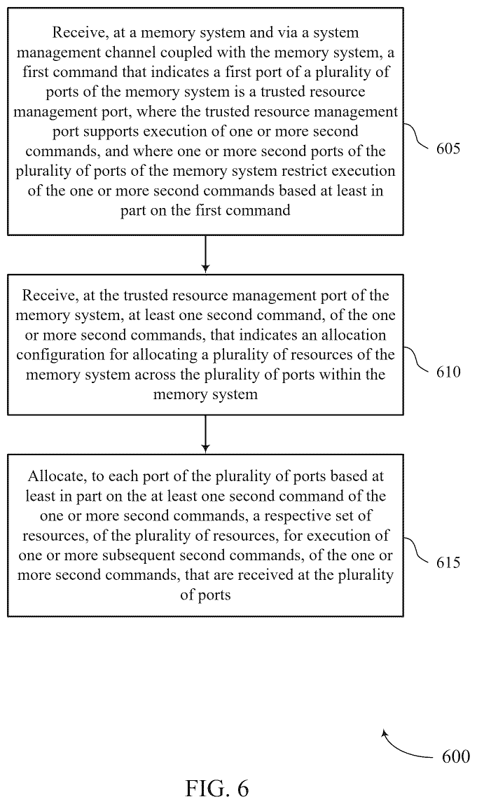

FIG. 6 shows a flowchart illustrating a method 600 that supports port resource management within a multi-port memory system in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving, at a memory system and via a system management channel coupled with the memory system, a first command that indicates a first port of a plurality of ports of the memory system is a trusted resource management port, where the trusted resource management port supports execution of one or more second commands, and where one or more second ports of the plurality of ports of the memory system restrict execution of the one or more second commands based at least in part on the first command. In some examples, aspects of the operations of 605 may be performed by a command component 430 as described with reference to FIG. 4.

At 610, the method may include receiving, at the trusted resource management port of the memory system, at least one second command, of the one or more second commands, that indicates an allocation configuration for allocating a plurality of resources of the memory system across the plurality of ports within the memory system. In some examples, aspects of the operations of 610 may be performed by a command component 430 as described with reference to FIG. 4.

At 615, the method may include allocating, to each port of the plurality of ports based at least in part on the at least one second command of the one or more second commands, a respective set of resources, of the plurality of resources, for execution of one or more subsequent second commands, of the one or more second commands, that are received at the plurality of ports. In some examples, aspects of the operations of 615 may be performed by a resource allocation component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for receiving, at a memory system and via a system management channel coupled with the memory system, a first command (e.g., a command 385-b) that indicates a first port of a plurality of ports of the memory system is a trusted resource management port, where the trusted resource management port supports execution of one or more second commands, and where one or more second ports of the plurality of ports of the memory system restrict execution of the one or more second commands based at least in part on the first command; receiving, at the trusted resource management port of the memory system, at least one second command, of the one or more second commands (e.g., command(s) 385-c), that indicates an allocation configuration for allocating a plurality of resources of the memory system across the plurality of ports within the memory system; and allocating, to each port of the plurality of ports based at least in part on the at least one second command of the one or more second commands, a respective set of resources, of the plurality of resources, for execution of one or more subsequent second commands, of the one or more second commands, that are received at the plurality of ports.

Aspect 12: The method, apparatus, or non-transitory computer-readable medium of aspect 11, where: the at least one second command, at least one of the one or more subsequent second commands received at the first port, or both, is associated with accessing user data or firmware of the memory system; and the first port supports execution of commands associated with accessing the user data or the firmware of the memory system.

Aspect 13: The method, apparatus, or non-transitory computer-readable medium of any of aspects 11 through 12, where: at least one of the one or more subsequent second commands received at the first port includes a power management command or a reset command; and the first port supports execution of sub-system operation commands.

Aspect 14: The method, apparatus, or non-transitory computer-readable medium of any of aspects 11 through 13, where: at least one of the one or more subsequent second commands received at the first port includes a diagnostic command; and the first port supports execution of diagnostic commands.

Aspect 15: The method, apparatus, or non-transitory computer-readable medium of any of aspects 11 through 14, where a same quantity of one or more respective resources is allocated to each port based at least in part on a quantity of ports, of the plurality of ports of the memory system; and the first command indicates the quantity of ports.

Aspect 16: The method, apparatus, or non-transitory computer-readable medium of any of aspects 11 through 15, where the plurality of resources includes command slots, namespace configurations, function resources, cache resources, interrupt resources, or any combination thereof.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 17: An apparatus, including: a plurality of memory devices; a plurality of ports coupled with the plurality of memory devices, where: a first port of the plurality of ports is coupled with one or more host systems via at least one physical function; and the first port is configured to communicate with the one or more host systems via a host interface in accordance with a first communication protocol; and a system management interface (e.g., interface 235) coupled with a system management controller via a system management channel (e.g., channel 355, IC2 bus, SMBus), where the system management controller is configured to allocate a plurality of resources within the apparatus to each port of the plurality of ports.

Aspect 18: The apparatus of aspect 17, where: one or more second ports of the plurality of ports of the apparatus are each coupled with one or more respective host systems via at least one respective physical function; and the one or more second ports are each configured to restrict execution of one or more second commands from the one or more respective host systems in accordance with one or more second communication protocols.

Aspect 19: The apparatus of any of aspects 17 through 18, where the first port of the plurality of ports includes the at least one physical function and one or more virtual functions associated with the at least one physical function.

Aspect 20: The apparatus of any of aspects 17 through 19, where the system management controller is configured to execute one or more commands associated with accessing user data or firmware of the apparatus.

Aspect 21: The apparatus of any of aspects 17 through 20, where the system management controller is configured to execute one or more sub-system operation commands.

Aspect 22: The apparatus of any of aspects 17 through 21, where the system management controller is configured to execute one or more diagnostic commands.

Aspect 23: The apparatus of any of aspects 17 through 22, where the system management controller is configured to allocate a same quantity of one or more respective resources to each port of the plurality of ports based at least in part on a quantity of the plurality of ports.

Aspect 24: The apparatus of any of aspects 17 through 23, where the plurality of resources includes command slots, namespace configurations, function resources, cache resources, interrupt resources, or any combination thereof.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive, at a first port of a plurality of ports of a memory system and from a first host system of a plurality of host systems, one or more commands associated with an attestation of the first host system;
receive, at the first port from the first host system based at least in part on the attestation of the first host system, a first command that indicates a quantity of ports, of the plurality of ports of the memory system, to be activated;
receive, at the first port from the first host system based at least in part on the attestation of the first host system, at least one second command, of one or more second commands, to allocate a plurality of resources of the memory system to the quantity of ports, wherein each port of the quantity of ports is coupled with one or more respective host systems of the plurality of host systems; and
allocate, to each port of the quantity of ports based at least in part on the one or more second commands, a respective set of resources of the plurality of resources.

2. The memory system of claim 1, wherein the processing circuitry is further configured to cause the memory system to:
receive, via the first command, an indication that the first port is a trusted resource management port, wherein the first port supports execution of the one or more second commands based at least in part on the indication.

3. The memory system of claim 1, wherein the processing circuitry is further configured to cause the memory system to:
receive, via a system management channel coupled with the memory system, a second command indicating that the first port is a trusted resource management port, wherein the first port supports execution of the one or more second commands based at least in part on the second command.

4. The memory system of claim 1, wherein the processing circuitry is further configured to cause the memory system to:
receive, at the quantity of ports including the first port and one or more second ports, one or more access commands; and
execute, at the quantity of ports, respective access commands of the one or more access commands based at least in part on the respective set of resources allocated to the quantity of ports.

5. The memory system of claim 1, wherein the at least one second command, a subsequent second command of the one or more second commands, or both, is associated with allocating access to user data, firmware, or both of the memory system to the quantity of ports.

6. The memory system of claim 1, wherein the processing circuitry is further configured to cause the memory system to:
receive, at the first port, a subsequent second command of the one or more second commands that comprises a power management command, a reset command, or both; and
execute a power management operation, a reset operation, one or more other privileged commands, or any combination thereof based at least in part on the subsequent second command.

7. The memory system of claim 1, wherein the processing circuitry is further configured to cause the memory system to:
receive, at the first port, a subsequent second command of the one or more second commands that comprises a diagnostic command; and
execute a diagnostic function based at least in part on the diagnostic command.

8. The memory system of claim 1, wherein allocating the respective set of resources to each port of the quantity of ports comprises the processing circuitry configured to cause the memory system to:
allocate, to each port of the quantity of ports, a same quantity of one or more resources based at least in part on the first command that indicates the quantity of ports.

9. The memory system of claim 1, wherein the plurality of resources comprises command slots, namespace configurations, function resources, cache resources, interrupt resources, or any combination thereof.

10. The memory system of claim 1, wherein the first port comprises a system management interface coupled with a system management controller.

11. An apparatus, comprising:
a plurality of memory devices;
a plurality of ports coupled with the plurality of memory devices, wherein:
a first port of the plurality of ports is coupled with one or more host systems via at least one physical function; and
the first port is configured to communicate with the one or more host systems via a host interface in accordance with a first communication protocol; and
a system management interface coupled with a system management controller via a system management channel, wherein the system management controller is configured to allocate a plurality of resources within the apparatus to each port of the plurality of ports.

12. The apparatus of claim 11, wherein:
one or more second ports of the plurality of ports of the apparatus are each coupled with one or more respective host systems via at least one respective physical function; and
the one or more second ports are each configured to restrict execution of one or more second commands from the one or more respective host systems in accordance with one or more second communication protocols.

13. The apparatus of claim 11, wherein the first port of the plurality of ports comprises the at least one physical function and one or more virtual functions associated with the at least one physical function.

14. The apparatus of claim 11, wherein the system management controller is configured to execute one or more commands associated with accessing user data or firmware of the apparatus.

15. The apparatus of claim 11, wherein the system management controller is configured to execute one or more sub-system operation commands.

16. The apparatus of claim 11, wherein the system management controller is configured to execute one or more diagnostic commands.

17. The apparatus of claim 11, wherein the system management controller is configured to allocate a same quantity of one or more respective resources to each port of the plurality of ports based at least in part on a quantity of the plurality of ports.

18. The apparatus of claim 11, wherein the plurality of resources comprises command slots, namespace configurations, function resources, cache resources, interrupt resources, or any combination thereof.

19. A memory system, comprising:
one or more memory devices; and
processing circuitry coupled with the one or more memory devices and configured to cause the memory system to:
receive, at a memory system and via a system management channel coupled with the memory system, a first command that indicates a first port of a plurality of ports of the memory system is a trusted resource management port, wherein the trusted resource management port supports execution of one or more second commands, and wherein one or more second ports of the plurality of ports of the memory system restrict execution of the one or more second commands based at least in part on the first command;
receive, at the trusted resource management port of the memory system, at least one second command, of the one or more second commands, that indicates an allocation configuration for allocating a plurality of resources of the memory system across the plurality of ports within the memory system; and
allocate, to each port of the plurality of ports based at least in part on the at least one second command of the one or more second commands, a respective set of resources, of the plurality of resources, for execution of one or more subsequent second commands, of the one or more second commands, that are received at the plurality of ports.

20. The memory system of claim 19, wherein:
the at least one second command, at least one of the one or more subsequent second commands received at the first port, or both, is associated with accessing user data or firmware of the memory system; and
the first port supports execution of commands associated with accessing the user data or the firmware of the memory system.

21. The memory system of claim 19, wherein:
at least one of the one or more subsequent second commands received at the first port comprises a power management command or a reset command; and
the first port supports execution of sub-system operation commands.

22. The memory system of claim 19, wherein:
at least one of the one or more subsequent second commands received at the first port comprises a diagnostic command; and
the first port supports execution of diagnostic commands.

23. The memory system of claim 19, wherein:
a same quantity of one or more respective resources is allocated to each port based at least in part on a quantity of ports, of the plurality of ports of the memory system; and
the first command indicates the quantity of ports.

24. The memory system of claim 19, wherein the plurality of resources comprises command slots, namespace configurations, function resources, cache resources, interrupt resources, or any combination thereof.

25. A method, comprising:
receiving, at a first port of a plurality of ports of a memory system and from a first host system of a plurality of host systems, one or more commands associated with an attestation of the first host system;
receiving, at the first port from the first host system based at least in part on the attestation of the first host system, a first command that indicates a quantity of ports, of the plurality of ports of the memory system, to be activated;
receiving, at the first port from the first host system based at least in part on the attestation of the first host system, at least one second command, of one or more second commands, to allocate a plurality of resources of the memory system to the quantity of ports, wherein each port of the quantity of ports is coupled with one or more respective host systems of the plurality of host systems; and
allocating, to each port of the quantity of ports based at least in part on the one or more second commands, a respective set of resources of the plurality of resources.

26. The method of claim 25, further comprising:
receiving, via the first command, an indication that the first port is a trusted resource management port, wherein the first port supports execution of the one or more second commands based at least in part on the indication; or
receiving, via a system management channel coupled with the memory system, a second command indicating that the first port is the trusted resource management port, wherein the first port supports execution of the one or more second commands based at least in part on the second command; or both.

27. The method of claim 25, wherein the at least one second command, a subsequent second command of the one or more second commands, or both, is associated with allocating access to user data, firmware, or both of the memory system to the quantity of ports.

28. The method of claim 25, further comprising:
receiving, at the first port, a subsequent second command of the one or more second commands that comprises a power management command, a reset command, or both; and
executing a power management operation, a reset operation, one or more other privileged commands, or any combination thereof based at least in part on the subsequent second command.

29. The method of claim 25, further comprising:
receiving, at the first port, a subsequent second command of the one or more second commands that comprises a diagnostic command; and
executing a diagnostic function based at least in part on the diagnostic command.

30. A method, comprising:
receiving, at a memory system and via a system management channel coupled with the memory system, a first command that indicates a first port of a plurality of ports of the memory system is a trusted resource management port, wherein the trusted resource management port supports execution of one or more second commands, and wherein one or more second ports of the plurality of ports of the memory system restrict execution of the one or more second commands based at least in part on the first command;
receiving, at the trusted resource management port of the memory system, at least one second command, of the one or more second commands, that indicates an allocation configuration for allocating a plurality of resources of the memory system across the plurality of ports within the memory system; and
allocating, to each port of the plurality of ports based at least in part on the at least one second command of the one or more second commands, a respective set of resources, of the plurality of resources, for execution of one or more subsequent second commands, of the one or more second commands, that are received at the plurality of ports.
